(19) United States
(12) Patent Application Publication
(10) Pub. No.: US 2017/0363183 A1
(43) Pub. Date: Dec. 21, 2017

(54) ATTACHMENT METHOD FOR PULLEY DEVICE AND DRIVE SHAFT AND ASSEMBLY FORMED THEREBY

(71) Applicant: Litens Automotive Partnership, Woodbridge (CA)

(72) Inventors: Boris Replete, Toronto (CA); Andrew M. Boyes, Aurora (CA); Hao Tran, North York (CA)

(21) Appl. No.: 15/534,063

(22) PCT Filed: Dec. 9, 2015
(86) PCT No.: PCT/CA2015/051300

§ 371 Date: Jun. 8, 2017

Related U.S. Application Data
(60) Provisional application No. 62/089,403, filed on Dec. 9, 2014.
(60) Provisional application No. 62/126,664, filed on Mar. 1, 2015.

(51) Int. Cl. F16H 7/20; F16H 57/00; F16H 55/36

(52) U.S. Cl. CPC F16H 7/20; F16H 57/0025; F16H 2055/366

(57) ABSTRACT

In an aspect, an assembly is provided and includes a pulley device and a drive shaft. The pulley device includes a pulley and has a shaft adapter. A selected amount of combined resistance in the first and second connections to relative rotation in the second direction is generated by a threaded first connection and a second connection between the shaft adapter and the shaft at least some of which is provided by a compression force between them.

### CROSS-REFERENCE TO RELATED APPLICATIONS

This application claims priority to U.S. Provisional Patent Application No. 62/089,403 filed Dec. 9, 2014, and U.S. Provisional Patent Application No. 62/126,664 filed Mar. 1, 2015, the contents of both of which are incorporated herein in their entirety.

### FIELD

This disclosure relates to pulley devices such as pulleys, isolators and TVDs (Torsional Vibration Dampers), and in particular to isolators that are used on a drive shaft such as an engine crankshaft or a motor-generator unit (MGU) shaft, in vehicles in which accessories can be driven by the MGU, and/or in which the engine can be started or boosted by the MGU through a belt (e.g. an engine equipped with a belt-alternator start (BAS) drive system).

### BACKGROUND

Isolators are known devices that are installed in accessory drive systems, on engine crankshafts and/or on accessory drive shafts for reducing the transmission of torsional vibrations from the crankshaft to a belt driven by the crankshaft and/or from the belt to the accessory drive shaft. In some instances where the engine is a hybrid engine that incorporates an MGU, the accessory drive system is operated in a first mode where the accessory drive belt is driven by the engine crankshaft and in turn drives the accessories, and in a second mode where the MGU drives the belt, which in turn drives the accessories (referred to as ISAF—Idle/Stop Accessory Function) and/or drives the engine crankshaft (such as during a BAS (Belt-Alternator Start) event, or a boost event where the MGU supplies additional power to the engine via the belt). In such systems, the isolator operates to transfer torque from the belt to a shaft in one mode, and operates to transfer torque from the shaft to the belt in the other mode. In order to ensure that the isolator remains fixed to the shaft to which it is installed, it is sometimes simply welded to the shaft. Welding is problematic, however, as it is time consuming and it requires grinding or the like in order to remove the isolator from the shaft, which will likely damage both the shaft and the isolator, thereby making the process of replacing a worn or defective isolator time consuming and expensive. In other cases an isolator may be keyed to the shaft. While a key arrangement is releasable, thereby facilitating removal and replacement of the isolator as needed, keying can be troublesome since some play can develop or is present from the beginning between the key and the key-receiving slot in the shaft, and/or between the key and the key-receiving slot in the isolator's shaft adapter.

It would be advantageous to be able to provide a connection that avoids damage to at least one of the shaft and the isolator during removal of the isolator from a drive shaft, such as the engine's crankshaft or an accessory shaft.

### SUMMARY

In an aspect, there is provided a A method of attaching a pulley device to a drive shaft, wherein the pulley device includes a pulley and has a shaft adapter that has a bore extending from a first axial end of the shaft adapter to a second axial end of the shaft adapter. The pulley device further includes a shaft adapter shoulder proximate the first axial end, a first shaft adapter connection structure which is threaded and is in the bore, and a second shaft adapter connection structure, the drive shaft including a shaft axial end, a shaft shoulder, a first shaft connection structure which is threaded, and a second shaft connection structure. The method includes:

a) inserting the shaft axial end into the bore and causing relative rotation between the shaft and the shaft adapter in a first direction to engage the first shaft adapter connection structure and the first shaft connection structure with one another to provide a first non-destructively releasable connection;

b) engaging the second shaft adapter connection structure and the second shaft connection structure with one another to provide a second connection; and

c) generating a selected amount of axial compression force between the shaft adapter shoulder and the shaft shoulder. Steps a), b) and c) together generate a selected amount of combined resistance in the first and second connections to relative rotation between the shaft and the shaft adapter in a second direction that is opposite the first direction.

In another aspect, an assembly is provided and includes a pulley device and a drive shaft. The pulley device includes a pulley and has a shaft adapter that has a bore extending from a first axial end of the shaft adapter to a second axial end of the shaft adapter. The pulley device further includes a shaft adapter shoulder proximate the first axial end, a first shaft adapter connection structure which is threaded and is in the bore, and a second shaft adapter connection structure. The drive shaft includes a shaft axial end, a shaft shoulder, a first shaft connection structure which is threaded and a second shaft connection structure. The first shaft adapter connection structure and the first shaft connection structure are engaged with one another to provide a first non-destructively releasable connection such that relative rotation of the shaft and the shaft adapter in a first direction tightens the first connection and relative rotation of the shaft and the shaft adapter in a second direction loosens the first connection. The second shaft adapter connection structure and the second shaft connection structure are engaged with one another to provide a second connection. The shaft adapter shoulder and the shaft shoulder are engaged with one another to generate a selected compression force therebetween. A selected amount of combined resistance in the first and second connections to relative rotation in the second direction is generated by the first and second connections and the compression force.

### BRIEF DESCRIPTION OF THE DRAWINGS

The foregoing and other aspects will now be described by way of example only with reference to the attached drawings, in which:

FIG. 1 is a side view of an engine in a vehicle containing a pulley device on a shaft of an MGU (motor-generator unit), according to non-limiting embodiments;

FIG. 2 is a perspective view of an example of the pulley device shown in FIG. 1;

FIG. 3 is a perspective exploded view of the pulley device shown in FIG. 2, including a shaft adapter and connected to a shaft of the MGU, with a portion cut away;

FIGS. 4-15 are perspective cutaway views that illustrate the assembling of the pulley device to the shaft of the MGU;

FIG. 15a is a sectional side view of a portion of the assembly formed by the pulley device and the shaft, showing forces and torques along the length of the shaft adapter;

FIG. 16 is a perspective cutaway view showing another embodiment of the pulley device and the assembly of the pulley device and the shaft of the MGU;

FIG. 17 is a sectional side view of another embodiment that is similar to the embodiment shown in FIG. 16 but with a solid pulley as the pulley device;

FIG. 18 is a perspective cutaway view showing yet another embodiment of the pulley device and the assembly of the pulley device and the shaft of the MGU;

FIG. 19 is a sectional side view of another embodiment that is similar to the embodiment shown in FIG. 18 but with a solid pulley as the pulley device;

FIG. 20 is a perspective cutaway view showing yet another embodiment of the pulley device and the assembly of the pulley device and the shaft of the MGU;

FIGS. 20-21 are perspective cutaway views that illustrate the assembling of another assembly of a pulley device and the shaft of the MGU;

FIG. 22 is a sectional side view of a variant of the assembly shown in FIG. 21.

### DETAILED DESCRIPTION OF EXAMPLE EMBODIMENTS

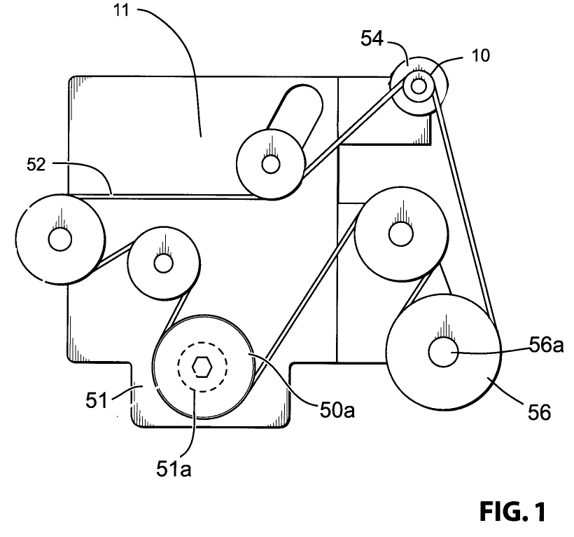

Reference is made to FIG. 1, which shows an example pulley device 10 for transferring power in an accessory drive system 11 between an endless drive member 52, such as an accessory drive belt, and a drive shaft. The endless drive member 52 is used to transfer power between a crankshaft pulley 50 mounted on a crankshaft 51a of an engine 51, and a plurality of accessory drive shafts including, for example, the drive shaft 54a of an MGU 54 and a drive shaft 56a of an air conditioning compressor 56. The pulley device 10 is shown as being mounted on the drive shaft 54a of the MGU 54. However, it will be understood that the pulley device 10 could additionally or alternatively be mounted on any other suitable drive shaft, such as the crankshaft 51a.

The endless drive member 52 may be referred to herein as the belt 52, for readability. However, it will be understood that it may be any other suitable endless drive member 52 may be used.

The engine 51 may be a hybrid engine. The accessory drive system 11 may be operated in a first mode where the belt 52 is driven by the engine crankshaft 51a and in turn drives the accessories, and in a second mode where the MGU 54 drives the belt 52, which in turn drives the accessories (referred to as ISAF—Idle/Stop Accessory Function) and/or drives the engine crankshaft 51a (such as during a BAS (Belt-Alternator Start) event, or a boost event where the MGU 54 supplies additional power to the engine 51 via the belt 52). Thus, torque is sometimes transferred from the belt 52 to the drive shaft 51a through the pulley device 10, and is sometimes transferred to the belt 52 from the drive shaft 51a through the pulley device 10.

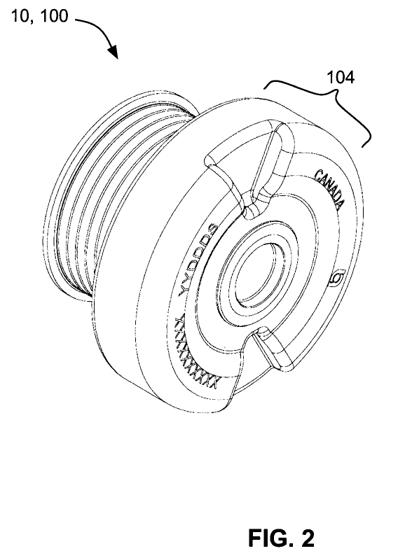

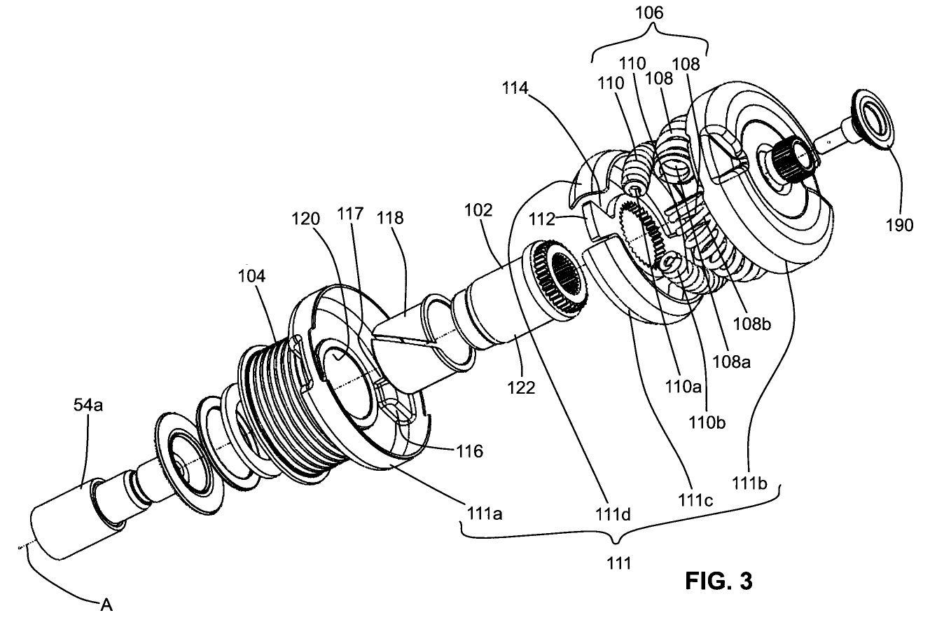

The pulley device 10 may be an isolator as shown at 100 in FIGS. 2 and 3, or it may be some other suitable type of pulley device 10 such as a solid pulley shown at 99 in FIG. 5.

In the embodiment shown in FIG. 3, the pulley device 10 includes a shaft adapter 102, a rotary drive member 104, and a spring arrangement 106. The shaft adapter 102 is used to mount the pulley device 10 to the drive shaft 51a, so as to form an assembly between pulley device 10 and the drive shaft 51a. Several embodiments of the shaft adapter 102 are described further below. The rotary drive member 104 may be any suitable type of rotary drive member such as a pulley. The rotary drive member 104 may be referred to as a pulley 104 for readability, in much the same way that the endless drive member 52 may be referred to as a belt 52, however it will be understood that any other suitable rotary drive member may be used.

The spring arrangement 106 includes at least one spring. In the example shown, the spring arrangement includes two primary, outer, arcuate, helical compression springs 108 and two secondary, inner, arcuate, helical compression springs 110 that are nested in the two outer springs 108 and operate in parallel with the springs 108. The springs 108 and 110 may generally be arranged to exhibit polar symmetry about the axis of rotation of the pulley device 10, shown at A. Other types of spring may alternatively or additionally be used in the spring arrangement 106.

The springs 108 and 110 may sit inside a spring shell 111 that is formed from a spring shell portions 111a, 111b, 111c and 111d. In the example shown, the spring shell 111 forms part of the pulley 104. The outer springs 108 each have a first spring end 108a and a second spring end 108b, while the inner springs 110 each have a first spring end shown at 110a and a second spring end 110b.

In the example shown, the shaft adapter 102 has a spring driver member 112 that has a plurality of first adapter spring drive surfaces 114 and second adapter drive surfaces 115 thereon for engagement with the springs 108 and 110. The pulley 104 includes a plurality of first pulley spring drive surfaces 116 and second pulley spring drive surfaces 117, for engagement with the ends 108a and 110 of the springs 108 and 110.

In the first mode described above for the accessory drive system 11, torque is applied to the pulley 104 from the belt 52 and may then be transferred from the pulley 104 through the spring arrangement 106 into the shaft adapter 102, and finally from the shaft adapter 102 into the drive shaft 54a. In the second mode described above, torque is applied to the shaft adapter 102 from the drive shaft 54a of the MGU 54 (FIG. 1) and is applied from the shaft adapter 102 through the spring arrangement 106 to the pulley 104, and from the pulley 104 to the belt 52. In the first mode, torque is transmitted from the first pulley spring drive surfaces 116 to the first spring ends 108a (and 110a if the torque is sufficiently high), and from the second spring ends 108b (and 110b if the torque is high enough) to the first adapter spring drive surfaces 114. In the second mode, torque is transmitted from the second adapter spring drive surfaces 117 to the first spring ends 108a (and 110a if the torque is sufficiently high), and from the second spring ends 108b (and 110b if the torque is high enough) to the second pulley spring drive surfaces 115.

The pulley 104 moves rotationally relative to the shaft adapter 10 in one direction or the other based on which way torque is being transferred. A bushing 118 may be provided between a pulley rotation surface 120 and a shaft adapter rotation surface 122.

Other components such as a dust cover, thrust washers, damping members, bushings and the like, are shown and may be provided as necessary for the operation of the pulley device 10. Apart from the description below relating to the structure of the shaft adapter 102 and its mounting to the drive shaft 54a, a suitable pulley device may, for example be as shown and described in PCT publication WO201206193A1 (which shows a helical torsion spring), or as shown and described in PCT publication WO2015027325A1 (which shows arcuate helical compression springs), the contents of both of which are incorporated fully herein by reference.

The shaft adapter 102 and the drive shaft 54a are described below in further detail.

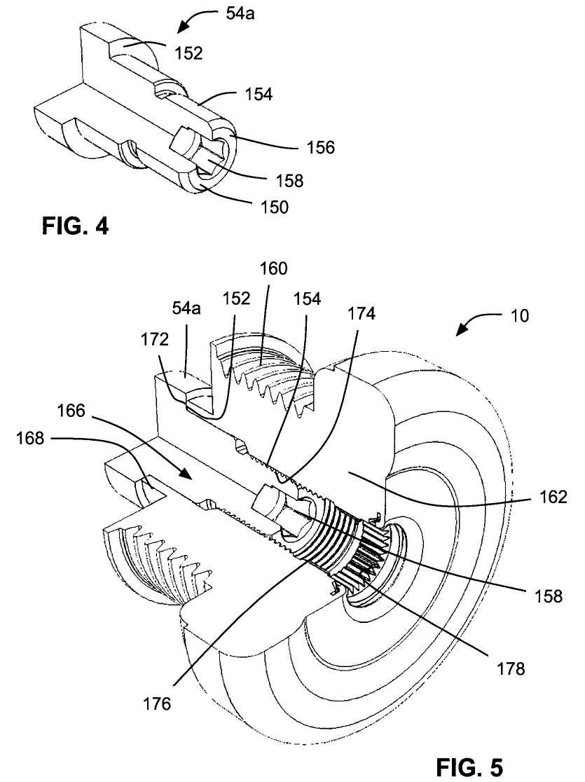

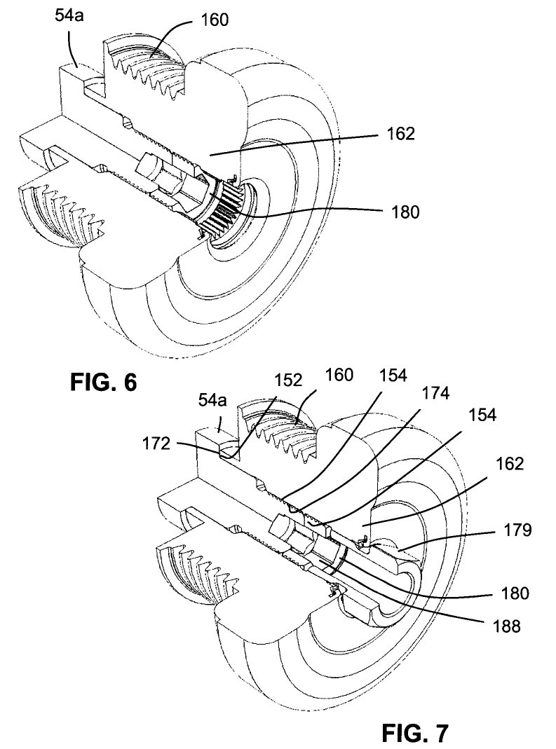

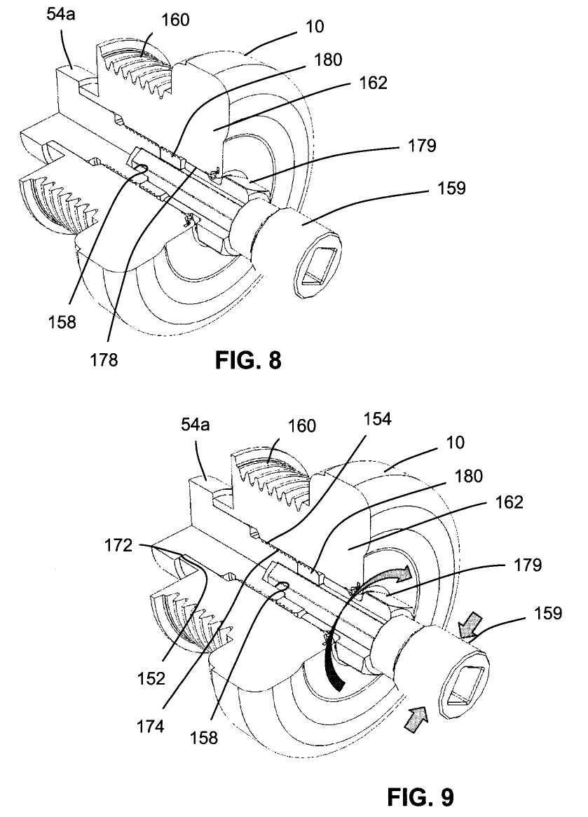

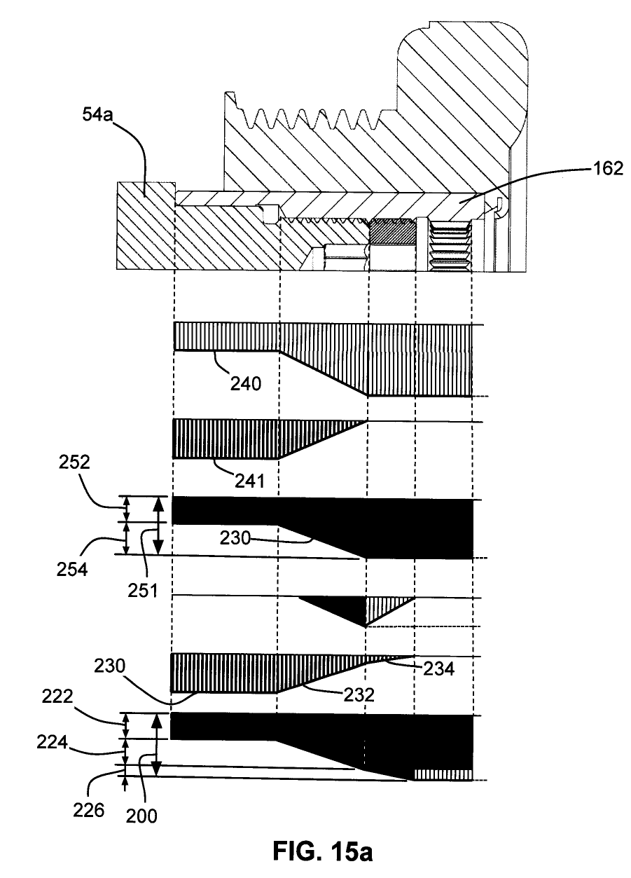

Reference is made to FIGS. 4-15. The drive shaft 54a is shown in FIG. 4 in section and the completed assembly of the drive shaft 54a and the pulley device 10 is shown in section in FIG. 15. The drive shaft 54a has a shaft axial end 150, a shaft shoulder 152, a first shaft connection structure 154 and a second shaft connection structure 156. The first shaft connection structure 154 may include an outside surface of the shaft 54a and may be threaded with, for example, a right hand thread (as is typical for threaded elements). The thread itself is not shown in FIG. 4, but is shown in FIG. 5. The second shaft connection structure 156 may be the face at the axial end 150 of the drive shaft 54a. The drive shaft 54a may further include a shaft tool receiving structure 158, which may, for example, be a hex-shaped aperture at the axial end 150, which receives a shaft tool 159 (FIG. 8).

For simplicity the pulley 10 is shown as a single solid item in FIGS. 5-15. As a result, it includes a pulley 160 and a shaft adapter 162 that are integral with one another. It will be understood however, that the pulley device 10 could be as shown in FIGS. 2 and 3, for example (or as in the aforementioned PCT publications) and could therefore include a pulley and a shaft adapter that are separate from one another and that transfer torque to one another through a spring arrangement.

The shaft adapter 162 has a bore 166 extending from a first axial end 168 of the shaft adapter 162 to a second axial end 170 of the shaft adapter 162. The pulley device 10 further includes a shaft adapter shoulder 172 proximate the first axial end 168, a first shaft adapter connection structure 174 that is in the bore 166, and a second shaft adapter connection structure 176. The first shaft adapter connection structure 174 is threaded and is configured to mate with the first shaft connection structure 154 (and which may therefore also have a right hand thread), so as to form a first, non-destructively releasable connection between the shaft adapter 162 and the shaft 54a as shown in FIG. 5. With their thread, relative rotation of the shaft 54 and the shaft adapter 162 in a first rotational direction (e.g. turning the shaft adapter 162 clockwise relative to the shaft 54a in the view shown in FIG. 5) tightens the first connection therebetween, while relative rotation of the shaft 54 and the shaft adapter 162 in a second rotational direction (e.g. turning the shaft 54a clockwise relative to the shaft adapter 162 in the view shown in FIG. 5), loosens the connection therebetween.

The second shaft adapter connection structure 176 may be threaded also, and may be an extension of the first shaft adapter connection structure 174, which facilitates manufacture of the shaft adapter 162. As shown in FIG. 15, the second shaft adapter connection structure 174 and the second shaft connection structure 154 are engaged with one another (indirectly, through a jam nut 180) to provide a second connection between the shaft adapter 162 and the shaft 54a. In the embodiment shown in FIGS. 4-15, the second connection is, like the first connection, non-destructively releasable.

In the example shown in FIGS. 4-15, the jam nut 180 has a first jam nut connection structure 182 (e.g. a threaded portion) that engages the second shaft adapter connection structure 174, and a second jam nut connection structure 184 (e.g. an axial end face 186) that engages the second shaft connection structure 154.

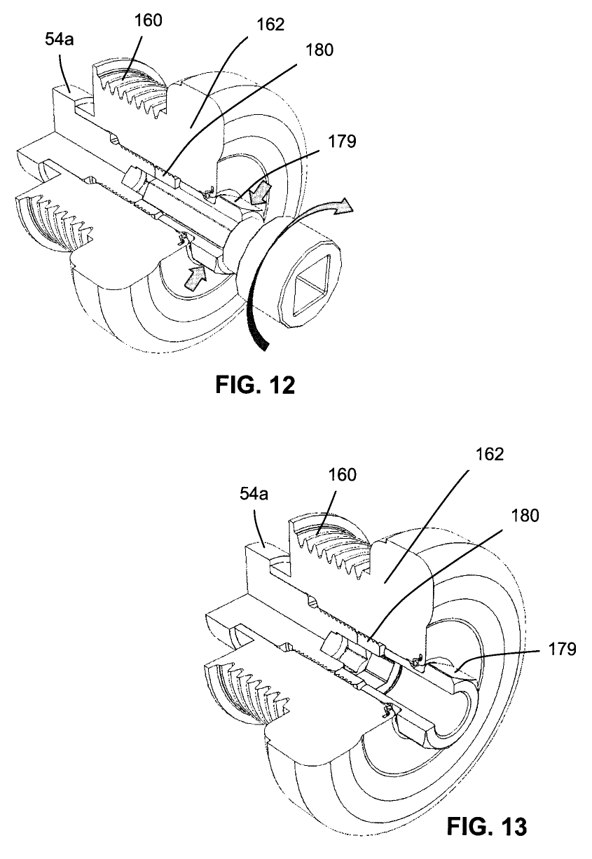

The shaft adapter 162 may further include a shaft tool receiving structure 178, which may, for example, include a toothed portion that engages a shaft adapter tool 179 (FIG. 7) that has a mating toothed portion. The use of the shaft and shaft adapter tool receiving portions 158 and 178 permit elements to be tightened or loosened relative to one another as needed during assembling or disassembling of the assembly. In the embodiment shown in FIGS. 4-15, the jam nut 180 further includes a jam nut tool receiving structure 188 (e.g. a hex-shaped aperture) that is shaped to receive a jam nut tool 189 (FIG. 12).

Reference is made to FIG. 15a, which shows the shaft adapter 162 and the shaft 54a. Shown in FIG. 15a are some torque values that can be used in some embodiments at different stages of assembling, and some forces that exist in the assembly at different stages of assembling. As can be seen, after the assembly has been completed, the shaft adapter shoulder and the shaft shoulder are engaged with one another to generate a selected compression force therebetween. There is a selected amount of combined resistance in the first and second connections to relative rotation in the second direction (i.e. the direction that would loosen the first connection). This combined resistance, which is shown at 200, is generated by the first and second connections and the compression force. In the example shown, the combined resistance is about 100 Nm. It will be noted that, while some resistance to rotation in the second direction is provided by the second connection formed via the jam nut 180, the jam nut 180 also helps the resistance to rotation in the second direction because it is less prone to movement vibration relative to the shaft adapter 162, due to the large discrepancy in size between them. Thus, it is less likely to unthread itself during any vibration or the like. As a result, it helps to keep an axial force between the shaft 54a and the shaft adapter 162, which in turn inhibits elimination of the axial forces (resulting from the compression force between the shoulders 152 and 172 that keeps the threaded connection portions 154 and 174 well engaged and therefore resistant to relative rotation in the loosening direction.

It will be observed that the compression force the shoulders 152 and 172 directly generates a first amount of resistance in the first connection to relative rotation in the second direction, and a second amount of resistance to relative rotation in the second direction at the second connection, since the compression force is distributed through the engagement of the threads in the first and second connections, which provides a normal force to generate frictional resistance to turning in the circumferential directions (both the first and second directions).

As can be seen for the compression force curve shown at 230 in FIG. 15a, the compression force at the shoulders 152 and 172 is high, and is distributed partially along the length of the first connection (see curve portion 232) and is distributed further along the length of the second connection (see curve portion 234).

As can be seen in the torque curve shown at 220, there is some frictional resistance to relative rotation in the second direction (shown at 222) at the surfaces 152 and 172, some further resistance to relative rotation in the second direction (shown at 224) along the length of the first connection, and some further resistance to relative rotation in the second direction (shown at 226) along the length of the second connection, which are all the direct result of the amount of compression force in the shaft adapter 162. Thus, the combined resistance to relative rotation in the second direction includes the first and second amounts of resistance (at the first and second connections). As can be see, the combined resistance to relative rotation in the second direction also includes the frictional resistance at the shoulders 152 and 172.

FIGS. 4-15 illustrate a method of assembling the assembly formed by the shaft 54a and the shaft adapter 162 and therefore of the assembly formed by the shaft 54a and the pulley device 10. With reference to FIG. 4, the shaft 54a is shown in isolation. In a step shown FIG. 5, the shaft adapter 162 is mounted to the shaft 54a by inserting the shaft axial end 150 into the bore 166 and causing relative rotation between the shaft 54a and the shaft adapter 162 in the first direction to engage the first shaft adapter connection structure 154 and the first shaft connection structure 174 with one another to provide the first connection. Another step includes engaging the second shaft adapter connection structure 176 and the second shaft connection structure 156 with one another to provide the second connection. Another step includes generating a selected amount of axial compression force (i.e. compression force shown in curve 230) between the shaft adapter shoulder 172 and the shaft shoulder 152. As noted above, although worded differently, the aforementioned three steps together generate a selected amount of combined resistance in the first and second connections to relative rotation between the shaft 54a and the shaft adapter 162 in the second direction. In relation to FIGS. 4-15, the second step noted above may include engaging the second shaft adapter connection structure 154 with the jam nut 180.

It will be noted that the step noted above relating to generating of the compression force occurs during the steps where the first and second connection structures are engaged to form the first and second connections.

In the particular embodiment shown in FIGS. 4-15, in order to tighten the first connection sufficiently, the shaft tool 159 and the shaft adapter tool 179 are inserted through the bore 166 and are used to rotate the shaft 54a and the shaft adapter 162 as needed in the first direction. At this point, the jam nut 180 is still loose. FIG. 7 illustrates the insertion of the shaft adapter tool 179 so as to engage the shaft adapter 162. FIG. 8 illustrates the insertion of the shaft tool 159 through an aperture in the shaft adapter tool 179. FIG. 9 illustrates the relative rotation carried out on the tools 159 and 179. The torque applied to the shaft adapter 162 along its length in FIG. 9, is represented by a torque curve 240 in FIG. 15a. The total applied torque may be, for example about 120 to about 130 Nm. This results in a compression curve 241 shown in FIG. 15a. As can be seen the compression force at the shoulders 152 and 172 is high and is distributed only over the first connection as shown by curve portion 242. The compression force results in a torque resistance curve 250 that shows a combined torque resistance 251 that includes a first torque resistance 252 that is analogous to the torque resistance shown at 222 in the curve 200, and a first torque resistance 254 that is analogous to the torque resistance 224 in the curve 200. In other words, when the jam nut 180 is loose, only the frictional resistance at the shoulders 152 and 172, and the frictional resistance along the threads of the first connection contribute to the total torque resistance. For greater clarity, the term torque resistance means the same thing as the resistance to relative rotation in the second direction. As can be seen, the torque resistance may be about 100 Nm.

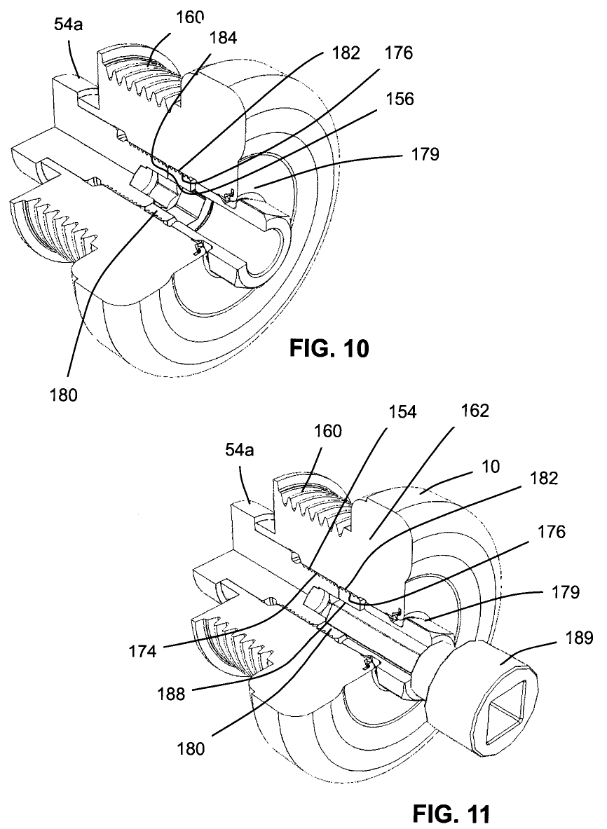

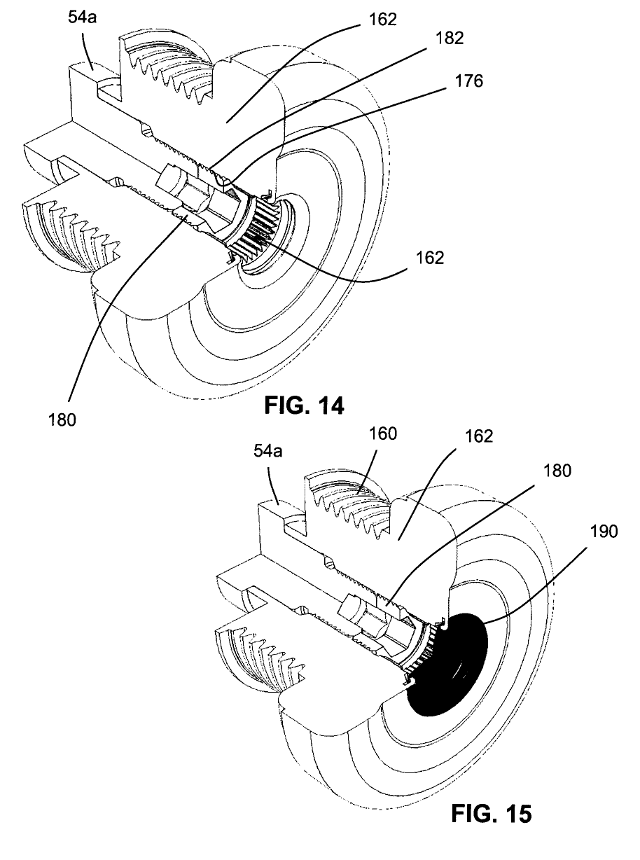

FIG. 10 illustrates removal of the tool 159. FIG. 11 illustrates insertion of the jam nut tool 189. The jam nut 180 may be alternatively referred to as a fastener and the tool 189 may be referred to as a fastener tool. FIG. 12 illustrates relative rotation (in the first direction) of the jam nut 180 and the shaft adapter 162 so as to drive the jam nut 180 tightly against the second shaft connection structure 154 and therefore against the second shaft adapter connection structure 174. The torque applied to the shaft adapter 162 as a result of using the tools 179 and 189 is shown at torque curve 260. The torque applied by the tools 179 and 189 may be about 60 to about 70 Nm. Once the tools 189 and 179 are removed (FIGS. 13 and 14 respectively), an end plug 190 (FIG. 15) may be inserted in the bore 166 to inhibit entry of dust or other contaminants. The compression force curve and the torque resistance curves at this stage are shown at 230 and 200 respectively. The assembly is completed as shown in FIG. 15. If no end plug 190 is used, the assembly is completed as shown in FIG. 14.

The disassembling of the assembly formed in FIG. 15 is carried out easily by reversing the actions carried to create the assembly. Thus the end plug 190 is removed, the tools 179 and 189 are used to rotate the jam nut 180 and the shaft adapter 162 in the second direction, and finally the tools 179 and 159 are used to rotate the shaft 54a and the shaft adapter 162 in the second direction until the shaft adapter 162 is removed from the shaft 54a.

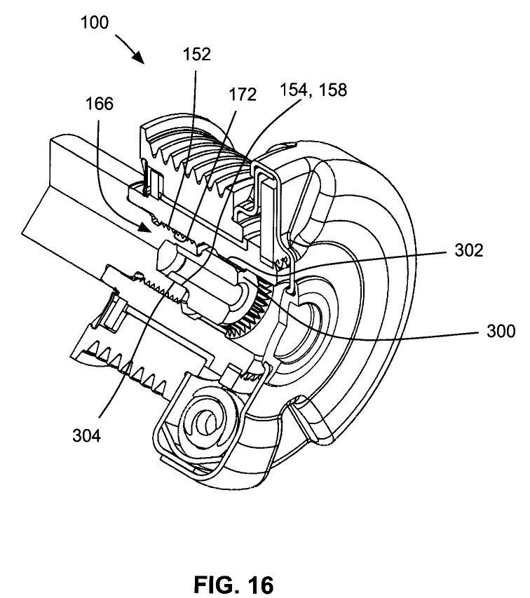

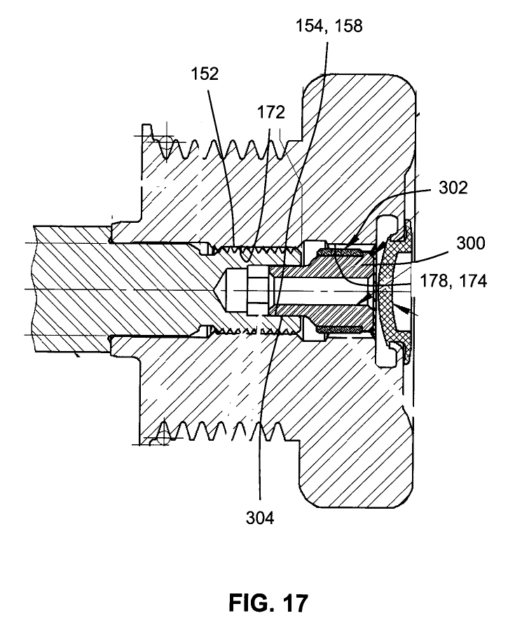

FIGS. 16 and 17 illustrate another embodiment of the present disclosure. FIG. 16 shows the isolator 100 in an assembled state as opposed to the exploded view shown in FIG. 3, but in cutaway so that the positional relationship between the elements making up the isolator 100 can be seen, whereas they are hidden in FIG. 2.

Also, FIG. 16 shows different second connection structures 154 and 174 for providing the second connection. In the embodiment shown in FIG. 16, the fastener shown at 300 is not a jam nut but is instead a different type of fastener. The fastener includes a first fastener connection structure 302 (shown more clearly in FIG. 17) that is a soft metallic layer, and a second fastener connection structure 304 that is a hex-shaped projection. The fastener 300 is pressed into the bore 166 such that the first connection structure 302 deforms and forms around the teeth that make up the shaft adapter tool receiving structure 178 and such that the hex-shaped projection snugly engages the shaft tool receiving structure 158. As a result, the second connection formed via the fastener 300 prevents any relative rotation in the second direction. However, it will be noted that the second connection shown in FIG. 16 is not a non-destructively releasable connection. To release such a connection, the fastener 300 may have to be drilled out.

As can be seen, the second connection structures 154 and 174 are also the tool receiving structures 158 and 178.

FIG. 17 shows the second connection as a side view, and shows the pulley device 10 as a solid pulley 99 instead of the isolator 100 shown in FIG. 16.

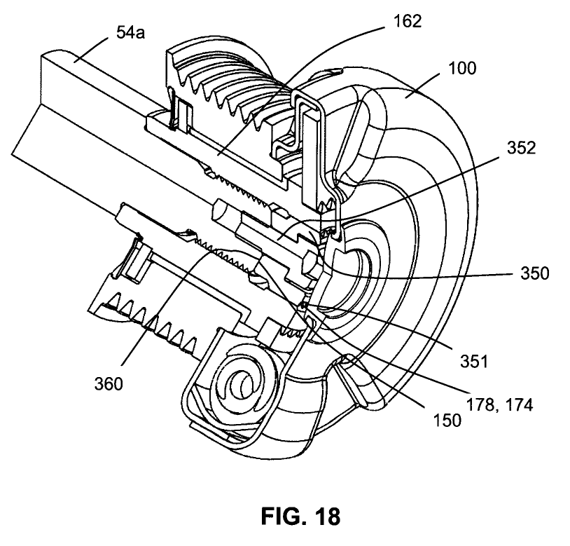

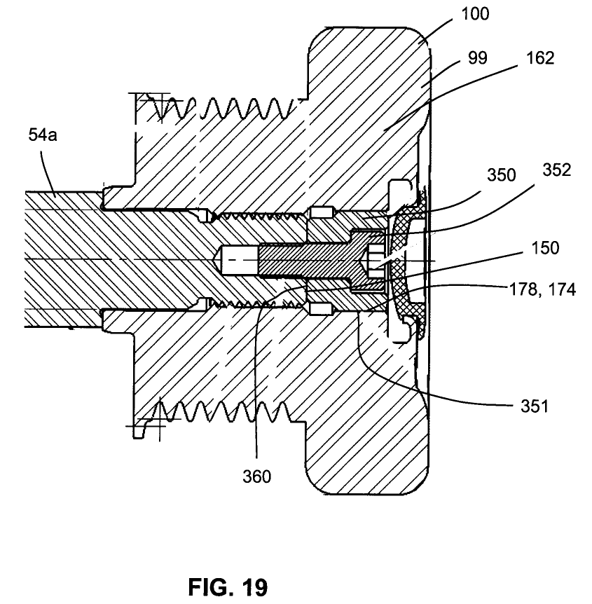

FIGS. 18 and 19 illustrate another embodiment of the present disclosure. FIG. 18 shows the isolator 100, whereas FIG. 19 shows the solid pulley 99. As shown in FIGS. 18 and 19, the second shaft connection structure 154 has a left handed thread (i.e. a thread having the opposite orientation to the thread in the first shaft connection structure 152 (which is also the shaft tool receiving structure 158). A transfer member 350 is slid into place axially in abutment with the axial shaft end 150. The transfer member 350 has a first transfer member connection structure 351 that is toothed and mates with the toothed shaft adapter tool receiving structure 178. Thus the shaft adapter tool receiving structure 178 is also the second shaft adapter connection structure 174. The fastener shown at 352 has a first fastener connection structure 354 that engages a second transfer member connection structure 356. The fastener further includes a second fastener connection structure 358 that is a left handed thread (i.e. the same thread orientation as the connection structure 152) and engages with the connection structure 152. The transfer member 350 has a third transfer member connection structure 360 that engages the axial end 150 of the shaft 54a. This arrangement forms the second connection between the shaft 54a and the shaft adapter 162. The second connection in this embodiment is a non-destructively releasable connection.

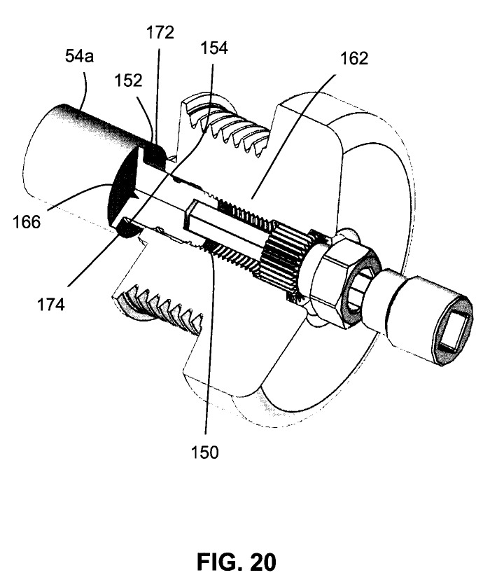

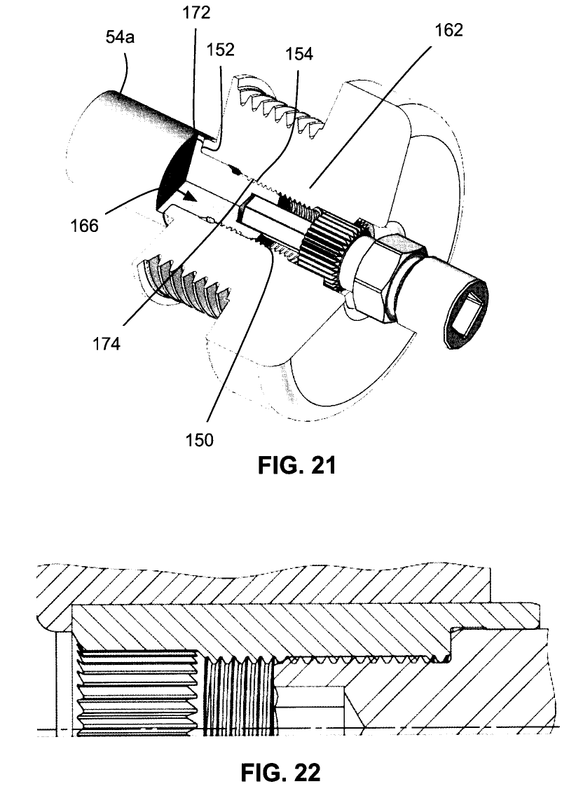

Reference is made to FIGS. 20-21 which show another embodiment. In this embodiment, the second shaft connection structure 154 includes a shaft press-fit surface 155 that is a portion of an outer surface of the shaft 54a, and the second shaft adapter connection structure 174 includes a shaft adapter press-fit surface 175 that is an inner surface in the bore 166. In this embodiment, the second method step described above includes inserting the shaft press-fit surface 155 into the bore 166 to mate with the shaft adapter press-fit surface 175.

In this embodiment, the second connection formed by the second connection structures 154 and 174 is non-destructively releasable. Furthermore, the second connection is not dependent on the axial compression force generated at the shoulders 152 and 172.

In this embodiment, the method of assembling the assembly is illustrated in FIGS. 20-21. More specifically, the first two steps described above occur at the same time, however, during these two steps, but prior to the third step where the axial compression force is generated (i.e. prior to engagement between the shoulders 152 and 172, the following steps are carried out. As a selected point during insertion of the axial shaft end 150 into the bore 166 such that partial engagement of the first connection structures 152 and partial engagement of the second engagement structures 154 and 174 has taken place, the method entails measuring a torque needed to continue carrying out the first two steps described above. In other words the torque required to continue rotating the shaft 54a and shaft adapter 162 in the first direction is measured. The method further includes only continuing to carry out the first two steps (i.e. continuing to rotate the shaft 54a and shaft adapter 162 in the first direction to further engage them) when the torque measured is within a selected range. The selected range may be, for example, between about 10 Nm and about 60 Nm. The selected point referred to above, may be when about three threads of the first shaft adapter connection structure 172 engage about three threads of the first shaft connection structure 152. If the torque measured is in the selected range, the connection structures may be fully engaged and the shoulders 152 and 172 may be engaged (FIG. 21). Thus, the compression force is generated and the combined torque resistance is provided by the first torque resistance at the first connection, the second torque resistance at the second connection and the third torque resistance at the engaged shoulders 152 and 172.

FIG. 22 shows a variant in which the second connection structure 154 on the shaft 54a is proximally located relative to the shoulder 152. The distal end of the shaft is the axial shaft end 150.

While the above description constitutes a plurality of embodiments of the present invention, it will be appreciated that the present invention is susceptible to further modification and change without departing from the fair meaning of the accompanying claims.

1. A method of attaching a pulley device to a drive shaft, wherein the pulley device includes a pulley and has a shaft adapter that has a bore extending from a first axial end of the shaft adapter to a second axial end of the shaft adapter, wherein the pulley device further includes a shaft adapter shoulder proximate the first axial end, a first shaft adapter connection structure which is threaded and is in the bore, and a second shaft adapter connection structure, the drive shaft including a shaft axial end, a shaft shoulder, a first shaft connection structure which is threaded, and a second shaft connection structure, the method comprising:
a) inserting the shaft axial end into the bore and causing relative rotation between the shaft and the shaft adapter in a first direction to engage the first shaft adapter connection structure and the first shaft connection structure with one another to provide a first non-destructively releasable connection;
b) engaging the second shaft adapter connection structure and the second shaft connection structure with one another to provide a second connection; and
c) generating a selected amount of axial compression force between the shaft adapter shoulder and the shaft shoulder, wherein steps a), b) and c) together generate a selected amount of combined resistance in the first and second connections to relative rotation between the shaft and the shaft adapter in a second direction that is opposite the first direction.

2. (canceled)

3. A method as claimed in claim 1, wherein the selected amount of compression force generates a first amount of resistance in the first connection to relative rotation between the shaft and the shaft adapter in a second direction that is opposite the first direction, and wherein there is a second amount of resistance to relative rotation between the shaft and the shaft adapter in the second direction at the second connection, wherein the combined resistance to relative rotation between the shaft and the shaft adapter in the second direction includes the first and second amounts of resistance.

4. (canceled)

5. A method as claimed in claim 1, wherein the second shaft adapter connection structure includes a plurality of first axially extending features, and the second shaft connection structure includes a plurality of second axially extending features and wherein step b) includes inserting a fastener to mate with the first and second axially extending features to prevent relative rotation therebetween.

6. A method as claimed in claim 1, wherein the second shaft connection structure includes a shaft press-fit surface that is a portion of an outer surface of the shaft, and the second shaft adapter connection structure includes a shaft adapter press-fit surface that is an inner surface in the bore, and wherein step b) includes inserting the shaft press-fit surface into the bore to mate with the shaft adapter press-fit surface.

7. A method as claimed in claim 6, wherein step a) and step b) are carried out at least partially simultaneously, and wherein, at a selected point during steps a) and b) but prior to completion of steps a) and b) and prior to step c) the method further comprises:
d) measuring a torque needed to continue carrying out steps a) and b); and
e) only continuing to carry out steps a) and b) when the torque is within a selected range.

8. A method as claimed in claim 7, wherein the selected point is when about three threads of the first shaft adapter connection structure engages about three threads of the first shaft connection structure.

9. A method as claimed in claim 7, wherein the selected range is about 10 Nm to about 60 Nm.

10. A method as claimed in claim 1, wherein the shaft axial end is a distal end of the shaft and wherein the shaft shoulder is positioned distally relative to the second shaft connection structure.

11. A method as claimed in claim 1, herein wherein the shaft axial end is a distal end of the shaft and wherein the shaft shoulder is positioned proximally relative to the second shaft connection structure.

12. A method as claimed in claim 1, wherein the bore in the shaft adapter has a shaft adapter tool receiving structure shaped to receive a first tool through the bore, and the shaft axial end has a shaft tool receiving structure therein shaped to receive a second tool through the bore, wherein the first and second tools are used together to engage the shaft adapter tool receiving structure and the shaft tool receiving structure respectively so as to drive relative rotation in the first direction during step a).

13. A method as claimed in claim 1, wherein the second shaft connection structure includes a face at the shaft axial end, and the second shaft adapter connection structure is threaded and wherein step b) includes engaging the second shaft adapter connection structure with a jam nut such that the jam nut is abutted with the second shaft connection structure.

14. (canceled)

15. An assembly, comprising:
a pulley device including a pulley and having a shaft adapter that has a bore extending from a first axial end of the shaft adapter to a second axial end of the shaft adapter, wherein the pulley device further includes a shaft adapter shoulder proximate the first axial end, a first shaft adapter connection structure which is threaded and is in the bore, and a second shaft adapter connection structure; and
a drive shaft including a shaft axial end, a shaft shoulder, a first shaft connection structure which is threaded and a second shaft connection structure,
wherein the first shaft adapter connection structure and the first shaft connection structure are engaged with one another to provide a first non-destructively releasable connection such that relative rotation of the shaft and the shaft adapter in a first direction tightens the first connection and relative rotation of the shaft and the shaft adapter in a second direction loosens the first connection,
wherein the second shaft adapter connection structure and the second shaft connection structure are engaged with one another to provide a second connection,
wherein the shaft adapter shoulder and the shaft shoulder are engaged with one another to generate a selected compression force therebetween
wherein a selected amount of combined resistance in the first and second connections to relative rotation in the second direction is generated by the first and second connections and the compression force.

16. An assembly as claimed in claim 15, wherein the pulley device is an isolator having a pulley and a shaft adapter.

17. An assembly as claimed in claim 15, wherein the selected amount of compression force generates a first amount of resistance in the first connection to relative rotation between the shaft and the shaft adapter in a second direction that is opposite the first direction, and wherein there is a second amount of resistance to relative rotation between the shaft and the shaft adapter in the second direction at the second connection, wherein the combined resistance to relative rotation between the shaft and the shaft adapter in the second direction includes the first and second amounts of resistance.

18. (canceled)

19. An assembly as claimed in claim 15, wherein the second shaft adapter connection structure includes a plurality of first axially extending features, and the second shaft connection structure includes a plurality of second axially extending features and wherein the assembly further includes a fastener that mates with both the first and second axially extending features to prevent relative rotation therebetween.

20. An assembly as claimed in claim 15, wherein the second shaft connection structure includes a shaft press-fit surface that is a portion of an outer surface of the shaft, and the second shaft adapter connection structure includes a shaft adapter press-fit surface that is an inner surface in the bore and that mates with the shaft press-fit surface.

21. An assembly as claimed in claim 15, wherein the shaft axial end is a distal end of the shaft and wherein the shaft shoulder is positioned distally relative to the second shaft connection structure.

22. An assembly as claimed in claim 15, wherein the shaft shoulder is positioned proximally relative to the second shaft connection structure.

23. An assembly as claimed in claim 15, wherein the bore in the shaft adapter has a shaft adapter tool receiving structure shaped to receive a first tool through the bore, and the shaft axial end has a shaft tool receiving structure therein shaped to receive a second tool through the bore.

24. An assembly as claimed in claim 15, wherein the second shaft connection structure includes a face at the shaft axial end, and the second shaft adapter connection structure is threaded and wherein a jam nut is engaged with the second shaft adapter connection structure such that the jam nut is abutted with the second shaft connection structure.

25. (canceled)
